(19) United States
(12) Patent Application Publication
(10) Pub. No.: US 2012/0086576 A1
(43) Pub. Date: Apr. 12, 2012

(54) MULTIFUNCTIONAL EMERGENCY LIGHTING DEVICE

(75) Inventor: CHIN-LUNG LIN, TAIPEI CITY (TW)

(73) Assignee: UNISTAR OPTO CORPORATION, TAIPEI (TW)

(21) Appl. No.: 13/253,183

(22) Filed: Oct. 5, 2011

(30) Foreign Application Priority Data
Oct. 12, 2010 (TW) 099219657

(51) Int. Cl. G08B 17/10; H02J 9/00

(52) U.S. Cl. 340/632; 362/20

(57) ABSTRACT

A multifunctional emergency lighting device includes at least one base formed of a heat sink, at least one LED lighting module, at least one emergency LED lighting module, a power control circuit, and at least one backup power supply device. The LED lighting module and the emergency LED lighting module are both mounted in the base. The power control circuit is connected to the LED lighting module and the emergency LED lighting module for converting AC to DC current for charging the backup power supply device and powers the LED lighting module and the emergency LED lighting module. In case of power failure of the electric main, the backup power supply device supplies electrical power to the power control circuit for powering the emergency LED lighting module in order to activate the emergency lighting of the emergency LED lighting module.

### BACKGROUND OF THE INVENTION

1. Field of the Invention

The present invention relates to a multifunctional emergency lighting device, and in particular to an emergency lighting device that is applicable to a power-saving lighting fixture and shows uses for both regular lighting and emergency lighting.

2. The Related Arts

An emergency light is commonly used for a single function of emergency lighting. An example is Taiwan Patent No. 433507, which discloses exit marking light and escape direction indication light, wherein the device is of sole purpose of emergency lighting and indication of escape route. Such a conventional device is only activated for emergency lighting and indication of escape router at the time when normal power supply fails or accidents happens. It provides no regular lighting, and this makes it simple a waste of lighting resources. Further, such an emergency lighting indicator is provided for install at an exit, which is generally not helpful to provide a large area illumination for a complicated office space or a shopping mall when accidents happen or when normal power supply to the illumination lighting is cut off.

A solution for such a problem is to modify a regular fluorescent lighting fixture or an alternate-current powered lighting fixture to form a dual-purpose lighting device for both emergency lighting and regular lighting. Such a solution is not practicable for the existing fluorescent lighting fixture or the alternate current powered lighting fixture are operated with alternate current and thus, an additional non-interrupted power supply device, which is often of a complicated structure and high cost, must be designed and provided. There is simply of no easy and cheap solution of using a direct current backup power supply, such as a direct current battery, to supply backup power for emergency operation of the lighting fixture. This makes the conventional emergency lighting confined within the very narrow scope of application as emergency lighting and showing no economic value of industrial use.

### SUMMARY OF THE INVENTION

The conventional LED (Light-Emitting Diode) emergency lighting device is generally of no use in providing effective indoor emergency lighting for a large area due to the limitation thereof to simply emergency lighting and this causes a waste of lighting resources and provides no economic value of industrial use.

In view of such a problem, it is desired to provide an emergency lighting device that shows duality of serving as regular lighting and emergency lighting to fully exploit limited lighting resources and to provide effective indoor lighting for a large area, and to enhance industrial use and economic value of multiple uses of LED based power-saving lighting facility.

Thus, an objective of the present invention is to provide a multifunctional emergency lighting device, which comprises at least one base, at least one LED lighting module, at least one emergency LED lighting module, a power control circuit, and at least one backup power supply device. The base is formed of a heat sink. The LED lighting module and the emergency LED lighting module are both mounted in the base. The power control circuit is mounted to the base and is connected to the LED lighting module and the emergency LED lighting module and functions to convert alternate current from for example an electric main into direct current that is supplied to and charges the backup power supply device and to supply electrical power for lighting the LED lighting module and the emergency LED lighting module. In case of power failure of the electric main, the backup power supply device supplies electrical power to the power control circuit for powering the emergency LED lighting module in order to activate the emergency lighting of the emergency LED lighting module. As such a lighting device that features both regular lighting and emergency lighting is provided.

The efficacy of the multifunctional emergency lighting device according to the present invention is that that arrangement of the LED lighting module, the emergency LED lighting module, and the power control circuit allows the LED lighting module and the emergency LED lighting module to collectively provide regular lighting and the arrangement of the backup power supply device provides power for activation of the emergency lighting of the emergency LED lighting module. As such, lighting resources can be effectively used and emergency lighting can be effectively made for a large indoor area in order to enhance industrial use and economic value.

### BRIEF DESCRIPTION OF THE DRAWINGS

The present invention will be apparent to those skilled in the art by reading the following description of preferred embodiments thereof, with reference to the attached drawings, wherein:

FIG. 1 is a perspective view showing a multifunctional emergency lighting device constructed in accordance with a first embodiment of the present invention;

FIG. 2 is an exploded view of FIG. 1;

FIG. 3 is back view of FIG. 1;

FIG. 4 is a block circuit diagram showing a power control circuit of the multifunctional emergency lighting device according to the present invention;

FIG. 5 is an exploded view showing a multifunctional emergency lighting device according to a second embodiment of the present invention;

FIG. 6 is a perspective view showing a multifunctional emergency lighting device according to a third embodiment of the present invention;

FIG. 7 is a block circuit diagram of the embodiment of FIG. 6; and

FIG. 8 is a plan view shown an application of the multifunctional emergency lighting device according to the third embodiment of the present invention.

### DETAILED DESCRIPTION OF THE PREFERRED EMBODIMENTS

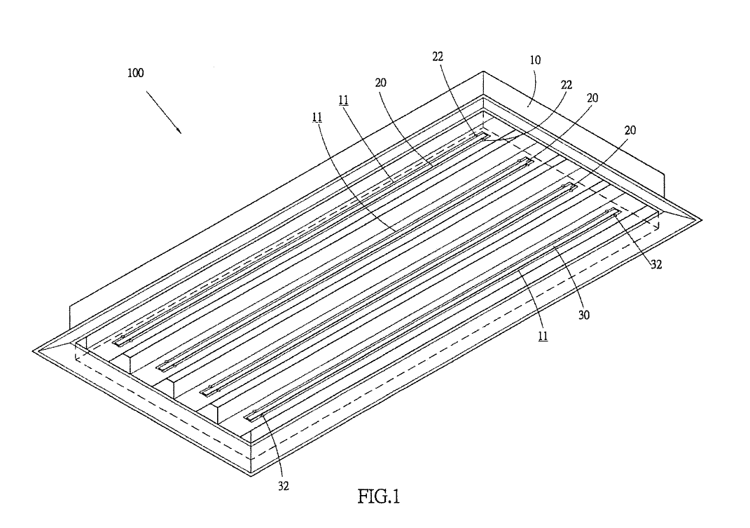

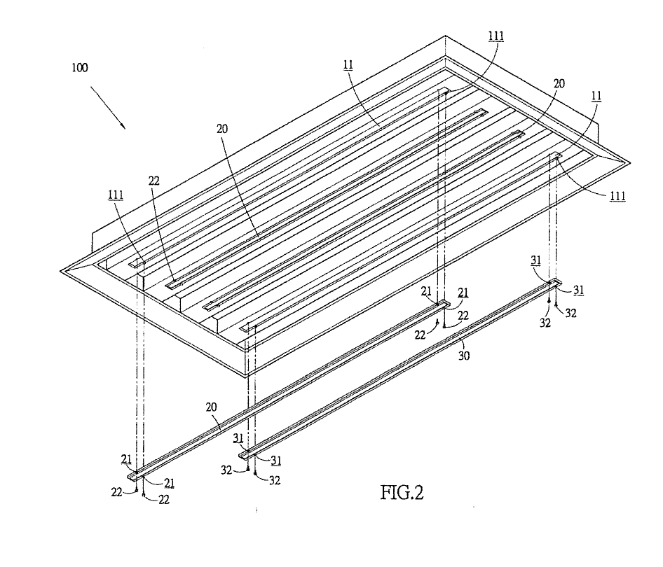

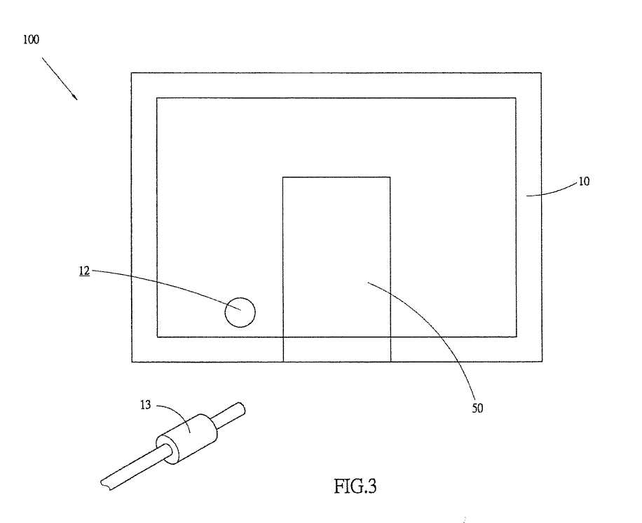

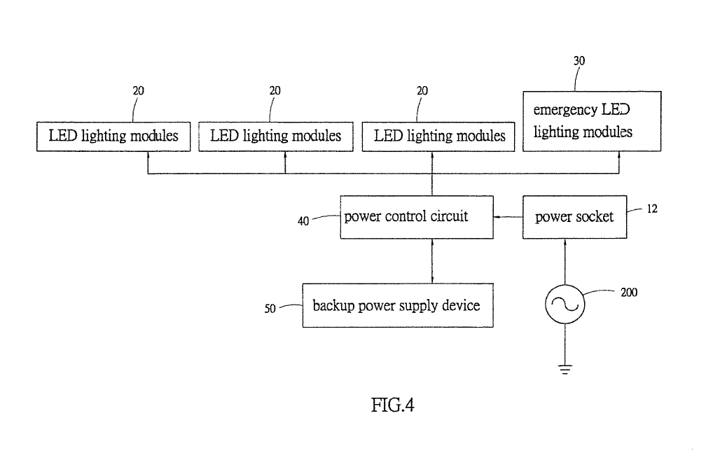

With reference to the drawings and in particular to FIGS. 1, 2, 3, and 4, a multifunctional emergency lighting device constructed in accordance with a first embodiment of the present invention is generally shown at 100. The multifunctional emergency lighting device 100 comprises at least one base 10, which is made of or comprises a heat sink or heat dissipater. The base 10 is not limited to any specific configuration or structure and in the first embodiment of the present invention, a ceiling light shell or casing is taken as an example for explanation. The base 10 has a surface that forms a plurality of recessed chambers 11, each of which has two ends each forming a plurality of inner-threaded holes 111. The base 10 has a back forming a power socket 12 (see FIG. 3) that is provided for receiving external power supply. Preferably, a power cable 13 is provided for connecting the external power supply socket 12 to an external power source 200, such an electric main (as schematically shown in FIG. 4).

At least one LED (Light-Emitting Diode) lighting module 20 is provided and a single multi-die packaged LED chip is taken as an example for explanation in the first embodiment. The LED lighting module 20 has a surface forming a plurality of through holes 21 corresponding in position to the inner-threaded holes 111 defined in the ends of the chambers 11 of the base 10 in order to receive screws 22 for securing purposes to thereby fix the LED lighting module 20 in at least one of the chambers 11 of the base 10. The base 10, therefore, realizes the functions of fixing and heat dissipation for the LED lighting module 20. The present invention is not limited to any specific number of LED lighting module 20 and in the first embodiment, three LED lighting modules 20 provided and respectively fixed in three of the chambers 11 of the base 10 are taken as an example of illustration.

At least one emergency LED lighting module 30 is provided, and a single multi-die packaged LED chip is taken as an example for explanation in the first embodiment. The emergency LED lighting module 30 has a surface forming a plurality of through holes 31 corresponding in position to the inner-threaded holes 111 defined in the ends of the chambers 11 of the base 10 in order to receive screws 32 for securing purposes to thereby fix the emergency LED lighting module 30 in at least one of the chambers 11 of the base 10. The base 10, therefore, realizes the functions of fixing and heat dissipation for the emergency LED lighting module 30. The present invention is not limited to any specific number of emergency LED lighting module 30 and in the first embodiment, one LED lighting module 20 provided and fixed in one of the chambers 11 of the base 10 is taken as an example of illustration.

At least one power control circuit 40 is arranged inside the base 10 for conversion between alternate-current power and direct-current power and control of non-interrupted power supplying, and control of ON/OFF switching of the LED lighting module(s) 20 and the emergency LED lighting module(s) 30 and is connected to the external power supply socket 12 of the base 10 for receiving electrical power supplied from the external power source 200, which is generally alternate current, and converting the electrical power from the external power source 200 into direct current. The power control circuit 40 is also connected to the LED lighting module 20 and the emergency LED lighting module 30 to supply the direct current for selectively lighting the LED lighting module 20 and the emergency LED lighting module 30.

At least one backup power supply device 50 is provided. The backup power supply device 50 is not limited to any specific type and in the instant embodiment, a rechargeable battery is taken as an example for illustration. The backup power supply device is arranged inside the base 10 and is electrically connected to the power control circuit 40, whereby in normal supply of electrical power from the external power source 200, the backup power supply device 50 receives electrical power from the power control circuit 40 and is thus charged and when the power control circuit 40 detects an abnormal failure or interruption of power supply from the external power source 200 due to for example a fire, the backup power supply device 50 is activated to supply backup electrical power to the power control circuit 40, which is thus enabled to supply DC electrical power to the emergency LED lighting module 30 for powering the emergency LED lighting module 30 to realize the function of emergency lighting.

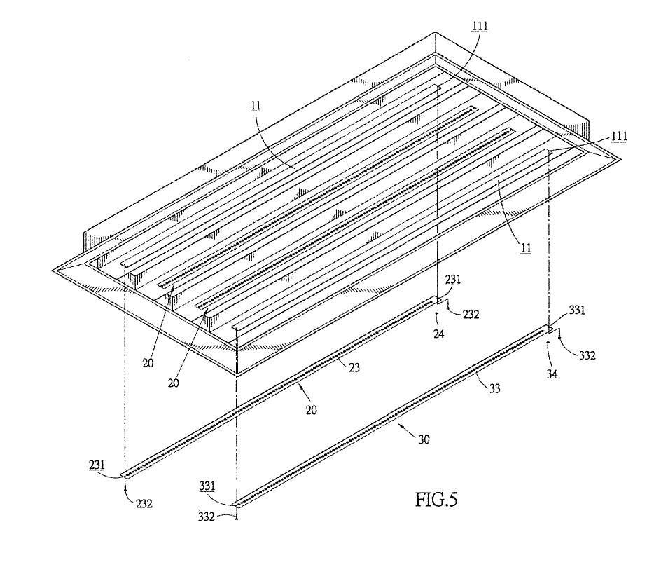

Referring to FIG. 5, a multifunctional emergency lighting device constructed in accordance with a second embodiment of the present invention is shown and is also designated at 100 for simplicity. In the second embodiment, the LED lighting module 20 and the emergency LED lighting module 30 are each a single-die light-emitting module, wherein the LED lighting module 20 comprises at least one circuit substrate 23 and a plurality of single-die LEDs 24. The circuit substrate 23 has two ends each forming a plurality of through holes 231 corresponding in position to the inner-threaded holes 111 defined in the ends of the chambers 11 of the base 10 and receiving a plurality of screws 232 therethrough to fix the circuit substrate 23 to the base 10. The circuit substrate 23 comprises conductive trace patterns formed on a surface thereof for electrically connecting the light-emitting diodes. The circuit substrate 23 is electrically connected to the power control circuit 40 so that the power control circuit 40 supplies a direct current through the circuit substrate 23 to the single-die LEDs 24, which are mounted to the circuit substrate 23 for selectively lighting each individual single-die LED 24.

Also, the emergency lighting module 30 comprises at least one circuit substrate 33 and a plurality of the single-die LEDs 34. The circuit substrate 33 has two ends each forming a plurality of through holes 331 corresponding in position to the inner-threaded holes 111 defined in the ends of the chambers 11 of the base 10 and receiving a plurality of screws 332 therethrough to fix the circuit substrate 33 to the base 10. The circuit substrate 33 comprises conductive trace patterns formed on a surface thereof for electrically connecting the light-emitting diodes. The circuit substrate 33 is electrically connected to the power control circuit 40 so that the power control circuit 40 supplies a direct current through the circuit substrate 33 to the single-die LEDs 34, which are mounted to the circuit substrate 33 for selectively lighting each individual single-die LED 34.

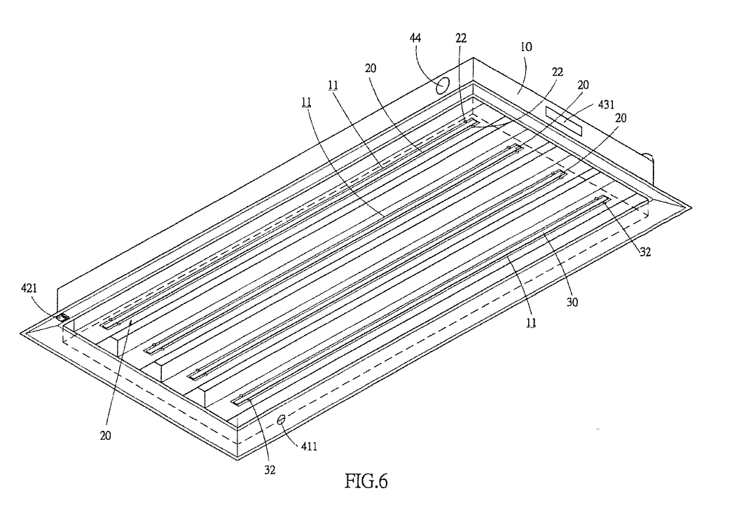

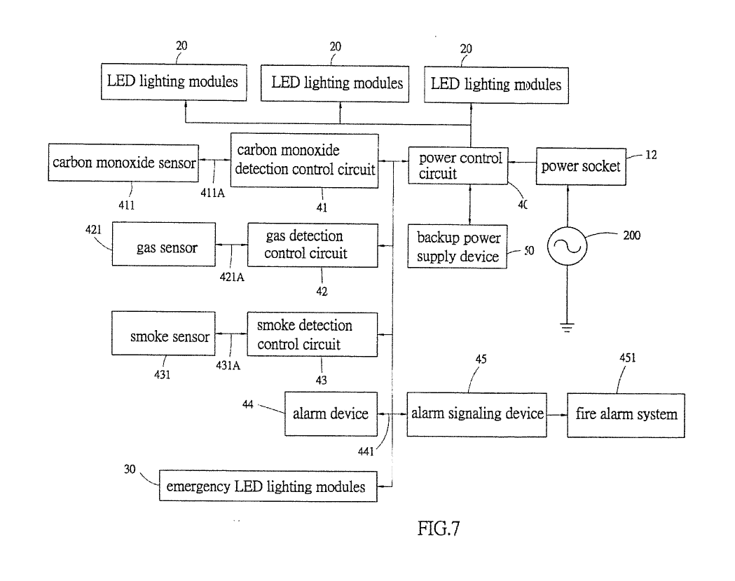

Referring to FIGS. 6 and 7, a multifunctional emergency lighting device constructed in accordance with a third embodiment of the present invention is shown and is also designated at 100 for simplicity. In the third embodiment, the power control circuit 40 is connected to at least one carbon monoxide detection control circuit 41, a gas detection control circuit 42, a smoke detection control circuit 43, an alarm device 44, and an alarm signaling device 45. The carbon monoxide detection control circuit 41 is connected to the power control circuit 40 and a carbon monoxide sensor 411. The carbon monoxide sensor 411 is arranged outside the base 10 to detect the concentration of carbon monoxide in the surrounding environment and generate a carbon monoxide detection signal 411A to the power control circuit 40 to serve as a reference signal based on which the power control circuit 40 activates emergency power control and alarming.

The gas detection control circuit 42 is connected to the power control circuit 40 and a gas sensor 421. The gas sensor 421 is arranged outside the base 10 to detect the concentration of fuel gas in the surrounding environment and generate a gas detection signal 421A to the power control circuit 40 to server as a reference signal based on which the power control circuit 40 activates emergency power control and alarming.

The smoke detection control circuit 43 is connected to the power control circuit 40 and a smoke sensor 431. The smoke sensor 431 is arranged outside the base 10 to detect the smoky condition in the surrounding environment and generate a smoke detection signal 431A to the power control circuit 40 to serve as a reference signal based on which the power control circuit 40 activates emergency power control and alarming.

The alarm device 44 is connected to the power control circuit 40, and the power control circuit 40, upon receiving a detection signal from one or more of the carbon monoxide detection control circuit 41, the gas detection control circuit 42, and the smoke detection control circuit 43, issues an alarm signal 441 to activate the alarm device 44. The alarm device 44 is not limited to any specific form and a buzzer that generates alarming sound for warning nearby people is taken as an example for illustration purposes.

The alarm signaling device 45 is connected to the power control circuit 40 and at least one fire alarm system 451. Besides issuing the alarm signal 441 to activate the alarm device 44 for warning nearby people, the power control circuit 40, upon receiving a detection signal from one or more of the carbon monoxide detection control circuit 41, the gas detection control circuit 42, and the smoke detection control circuit 43, also applies the alarm signal 441 to the fire alarm system 451, which can be a central control facility or a management chamber of a building, or a remote fire alarm receiver arranged at each floor of the building, in order to show the alarm message to an on-duty remote monitoring personnel so that the monitoring personnel may immediately take emergency handling operations.

The carbon monoxide detection control circuit 41, the carbon monoxide sensor 411, the gas detection control circuit 42, the gas sensor 421, the smoke detection control circuit 43, the smoke sensor 431, the alarm device 44, and the alarm signaling device 45 are operated, in a normal condition, by electrical power received from the external power source 200 through the power control circuit 40. In case of power failure or interrupted supply of the external power source 200, the backup power supply device 50 is activated to supply direct current through the power control circuit 40 to the carbon monoxide detection control circuit 41, the carbon monoxide sensor 411, the gas detection control circuit 42, the gas sensor 421, the smoke detection control circuit 43, the smoke sensor 431, the alarm device 44, and the alarm signaling device 45 to maintain the operations of the detection circuits, the sensors, and the alarm devices.

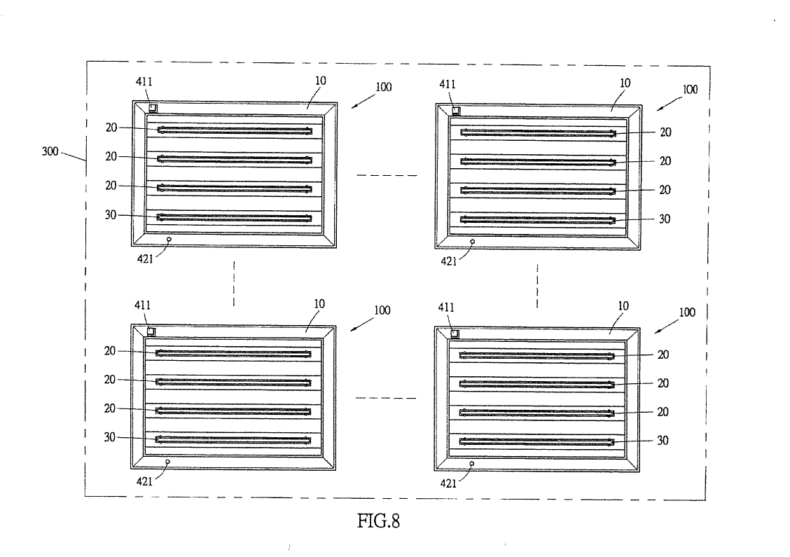

Referring to FIG. 8, an application of the present invention is shown, wherein a number of multifunctional emergency lighting devices 100 according to the third embodiment of the present invention shown in FIG. 7 are mounted in a ceiling 300. In a normal situation, the LED lighting modules 20 and the emergency LED lighting modules 30 of the multifunctional emergency lighting devices 100 are properly power to give off lighting for illuminating the indoor space; and the carbon monoxide sensor 411 of the carbon monoxide detection control circuit 41, the gas sensor 421 of the gas detection control circuit 42, and the smoke sensor 431 of the smoke detection control circuit 43 that are connected to the power control circuit 40 respectively perform detections of the concentrations of carbon monoxide, gas, or smoke in the indoor space. When any detection of carbon monoxide, gas, and smoke in the indoor space is identified, the power control circuit 40 controls the alarm device 44 to issue an alarm. Further, when the external power source 200 accidentally fails or is interrupted, the power control circuit 40 receives backup power from the backup power supply device 50 to maintain lighting condition of the emergency LED lighting modules 30. The emergency LED lighting modules 30 of the multifunctional emergency lighting devices 100 are designed to provide a proper and effective emergency lighting for a large area in order to guide people to escape and to perform emergency evacuation.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A multifunctional emergency lighting device, comprising:
at least one base, which has a surface forming a plurality of recessed chambers;
at least one LED lighting module, which is received and fixed in at least one of the chambers of the base;
at least one emergency LED lighting module, which is received and fixed in at least one of the chambers of the base;
at least one power control circuit, which is arranged inside the base to perform functions of controlling ON/OFF switching of the LED lighting module and the emergency LED lighting module, conversion between direct current and alternate current, control of non-interrupted power supply, and control of the LED lighting module and the emergency LED lighting module for illumination in normal operation of an external power source and activation of emergency lighting of the emergency LED lighting module in failure or interruption of the external power source; and
at least one backup power supply device, which is arranged inside the base and connected to the power control circuit for selective supply of direct current to the power control circuit for the activation of the emergency lighting of the emergency LED lighting module.

2. The multifunctional emergency lighting device as claimed in claim 1, wherein the base comprises a heat sink.

3. The multifunctional emergency lighting device as claimed in claim 1, wherein each of the chambers has two ends each forming a plurality of inner-threaded holes.

4. The multifunctional emergency lighting device as claimed in claim 1, wherein the base forms an external power supply socket.

5. The multifunctional emergency lighting device as claimed in claim 3, wherein the external power supply socket is adapted to connect through a power cable to an external power source.

6. The multifunctional emergency lighting device as claimed in claim 1, wherein the LED lighting module comprises a multi-die packaged LED chip.

7. The multifunctional emergency lighting device as claimed in claim 1, wherein the LED lighting module comprises:
at least one circuit substrate, which is received and fixed in the chambers of the base, the circuit substrate having a surface forming conductive trace patterns for connecting light-emitting diodes; and
a plurality of single-die LEDs, each of which is mounted to the circuit substrate so that the single-die LED receives direct current from the circuit substrate for lighting.

8. The multifunctional emergency lighting device as claimed in claim 1, wherein the emergency LED lighting module comprises a multi-die packaged LED chip.

9. The multifunctional emergency lighting device as claimed in claim 1, wherein the emergency LED lighting module comprises:
at least one circuit substrate, which is received and fixed in the chambers of the base, the circuit substrate having a surface forming conductive trace pattern for connecting the light-emitting diodes; and
a plurality of single-die LEDs, each of which is mounted to the circuit substrate so that the single-die LED receives direct current from the circuit substrate for lighting.

10. The multifunctional emergency lighting device as claimed in claim 1, wherein the power control circuit is connected to at least one alarm signaling device.

11. The multifunctional emergency lighting device as claimed in claim 10, wherein the alarm signaling device is connected to at least one fire alarm system.

12. The multifunctional emergency lighting device as claimed in claim 1, wherein the power control circuit is connected to at least one carbon monoxide detection control circuit.

13. The multifunctional emergency lighting device as claimed in claim 12, wherein the carbon monoxide detection control circuit is connected to a carbon monoxide sensor to detect concentration of carbon monoxide in a surrounding environment and generate a carbon monoxide detection signal to the power control circuit to serve as a reference signal based on which the power control circuit activates emergency power control and alarming.

14. The multifunctional emergency lighting device as claimed in claim 1, wherein the power control circuit is connected to at least one gas detection control circuit.

15. The multifunctional emergency lighting device as claimed in claim 14, wherein the gas detection control circuit is connected to a gas sensor to detect concentration of gas in a surrounding environment and generate a gas detection signal to the power control circuit to serve as a reference signal based on which the power control circuit activates emergency power control and alarming.

16. The multifunctional emergency lighting device as claimed in claim 1, wherein the power control circuit is connected to at least one smoke detection control circuit.

17. The multifunctional emergency lighting device as claimed in claim 16, wherein the smoke detection control circuit is connected to a smoke sensor to detect a smoky condition in a surrounding environment and generate a smoke detection signal to the power control circuit to serve as a reference signal based on which the power control circuit activates emergency power control and alarming.

18. The multifunctional emergency lighting device as claimed in claim 1, wherein the power control circuit is connected to at least one alarm device.

19. The multifunctional emergency lighting device as claimed in claim 18, wherein the alarm device comprises a buzzer.

20. The multifunctional emergency lighting device as claimed in claim 1, wherein the backup power supply device comprises a rechargeable battery.
